(19) United States
(12) Patent Application Publication
(10) Pub. No.: US 2012/0117813 A1
(43) Pub. Date: May 17, 2012

(54) Enclosure Alignment System

(76) Inventors: Terry Stevenson, Gillette, WY (US); Justin Modlin, Billings, MT (US)

(21) Appl. No.: 13/071,403

(22) Filed: Mar. 24, 2011

Related U.S. Application Data
(60) Provisional application No. 61/380,446, filed on Sep. 7, 2010.

(51) Int. Cl. G01B 11/14

(52) U.S. Cl. 33/286

(57) ABSTRACT

A pipe alignment device and method is provided for locating and identifying the receiving end of pipe or conduit wherein the invention allows an individual to pinpoint the destination of any pipe or round chase from its origin. This process eliminates the need for multiple measurements to recreate the parameters of the origin at the destination.

### PREVIOUS FILING

This application emanates from a previous application filing which is related to, and claims priority through earlier filed U.S. Provisional application No. 61380446., Sep. 7, 2010 all the subject matter of which are herein incorporated by this reference thereto in their entirety for all purposes.

### FIELD OF THE INVENTION

The present invention relates generally to laser-based pipe or conduit alignment systems which use a reference beam of light along a predetermined path to position is sections of pipe and, more particularly, to a pipe alignment device which provides abeam of light to identify the location of the proposed enclosure or conduit.

### BACKGROUND OF THE INVENTION

Reference laser beam systems have been employed in a number of surveying and construction applications. Laser beam systems have been used, for example, to great advantage in laying sections of pipe, such as electrical conduit. A laser beam transmitter provides a stationary laser beam, which passes through the previously positioned sections along a central axis and establishes a reference line of light. A laser beam target having reference indicia thereon is placed in one end of a section of pipe to assist workers in positioning the section or determine where a section will connect. The end of the pipe opposite the laser target is then aligned with the end of the previously laid section, where applicable. The pipe section is maneuvered until the reference beam of light strikes the reference indicia on the target. Support material such as gravel, is then placed beneath the pipe section, holding it in place.

A continuing problem associated with prior art laser-based pipe alignment systems is the deflection of the laser beam caused by thermal stratification of the air in the pipe or positioning of the laser in a quick and efficient manner. As is well known in the art, the positioning of the laser is a critical part of the preparation stage or more harm can be done than good. If the laser is not properly placed or attached to the extending pipe or conduit, the focal or end point of the laser will be incorrect causing expensive if not damaging results. For example, all lasers may shoot a straighten line, however, if the laser is not properly attached or aligned with the pipe that has already been installed, the laser direction is completely subject to its handler.

U.S. Pat. No. 2,549,911 to Lee discloses an elongated table with an adjustable pipe bed mounted atop the table for supporting pipe having a small range of diameter and lengths. A protractor plate is also mounted on the table and is set to the desired angle to which the pipe is to be cut. Once the pipe is secured on the table by means of the adjustable pipe bed and the protractor is set to the desired angle, an arm member is securely fastened to one end of the pipe to be cut. The arm member is in continual abutment with the protractor so that, as the pipe is rotated, it reciprocates longitudinally enabling a marker to scribe a severance line around the entire circumference of the pipe. After the pipe is detached from the table it is cut along the severance line.

Although the Lee patent is capable of scribing a severance line on pipe having a small range of sizes, it is incapable of scribing a line on both small diameter pipe and large diameter pipe (in the order of 4 foot or more) of any length. Moreover, the Lee patent fails to mention employing the device for scribing a beveled cut in addition to an angled cut.

U.S. Pat. No. 3,238,623 to Lee discloses a pipe layout device having a base portion, which is held securely to the pipe to be marked, by means of a chain, which wraps around the circumference of the pipe. Mounted upon the base portion is a guide bar, which is attached to a holding arm and a holder. The guide bar includes a reference means with degree marks indicating the desired angle to which the pipe is to be cut. This device is capable of marking the entire circumference of the pipe, by first marking the upper portion of the pipe, and then sliding the holding arm to the lower portion of guide bar and marking the lower portion of the pipe.

While this device is capable of marking the entire circumference of the pipe, accuracy is lost when the holding arm is moved from the upper portion of the guide bar to the lower portion of the guide bar. Furthermore, this device is unable to cut pipe having a large range of diameters because of the limiting length of the holding arm and holder. Moreover, this device requires the pipe to be lifted or elevated in order to permit the holding arm and holder to mark the entire circumference of the pipe. Additionally, the Lee patent fails to mention employing the layout device for scribing a beveled cut and an angled cut.

Thus, a need exists for developing an adjustable device capable of indicating the exact pipe diameter without the need for additional measuring systems or tools.

The invention allows an individual to pinpoint the destination of any pipe or round chase from its origin. This process eliminates the need for multiple measurements to recreate the parameters of the origin at the destination.

### SUMMARY OF THE INVENTION

This need is met by the improved pipe alignment device and method of the present invention wherein the laser is temporarily and easily attached to the end of the pipe or conduit, which requires extending. The pipe alignment device includes a light transparent aperture such that a reference beam of light may be transmitted through the aperture and into the pipe concurrently with the generation of the beam of light.

The current device provides an exact center with NO steps (once the device is placed) Since the use of a “hole saw” or knock out” is required to pass through an adjacent obstruction the need to know exact center is necessary due to the fact that a “hole saw” or “knock out” comes pre-sized to accommodate any and all variations in conduit or pipe with a “pilot bit” or bolt machined to its exact center.

A pipe/conduit center or outside diameter distance locator

A device approximately 2 to 3 inches long with threads staged at multiple specific increments.

Therefore, it would be beneficial to provide an improved laser, which overcomes the drawbacks of the prior art.

Accordingly, it is an object of the invention to provide a versatile wherein assembly and disassembly can be easily accomplished,

### BRIEF DESCRIPTION OF THE DRAWINGS

FIG. 1 is the front view of the device.

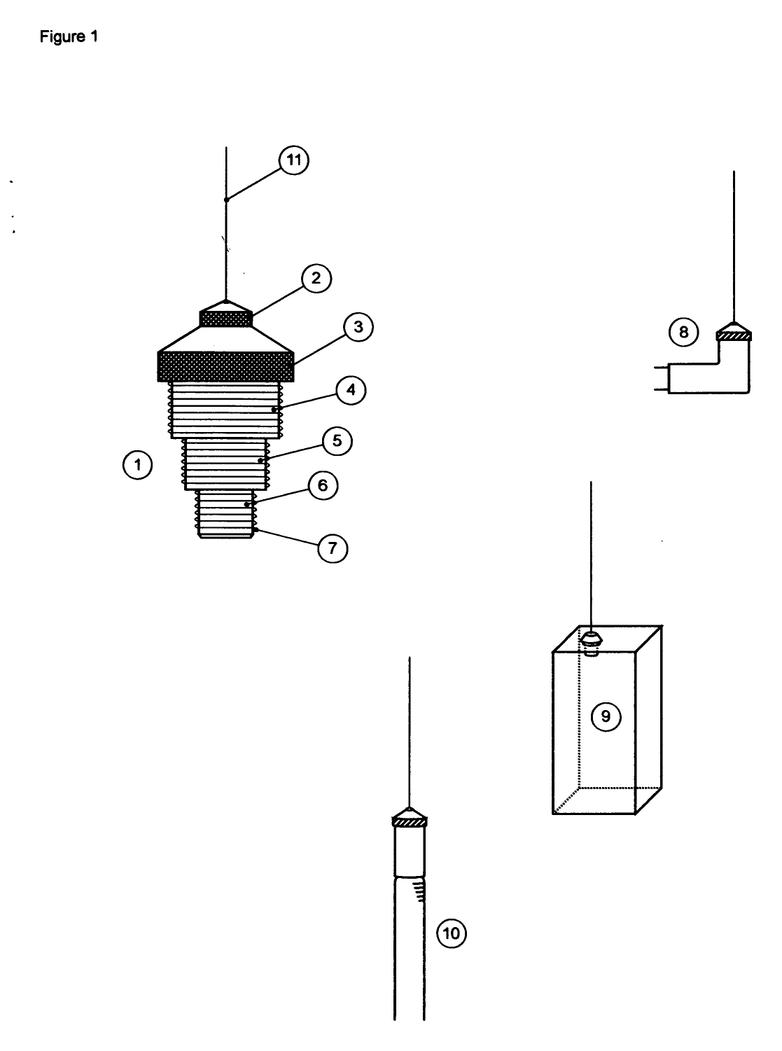

### DETAILED DESCRIPTION OF THE DRAWINGS

Today's standard of marking holes in which conduit will pass through is to first level the conduit or box, place a laser level at the point of origin, mark the spot, measure the base of the level to the laser center then measure conduit “OD” and divide in half. Add the two measurements together then take this measurement and measure off of laser mark. It is truly allot of steps for something that can be done in five seconds.

With this product an individual can simply screw in the device (as in illustrations #1 and #3) turn the laser on and mark the whole. Another application (as in illustration #2) the device can be dropped through a knock out or existing hole, screw on the lock nut to secure it then turn the laser on to mark the hole. The device is designed for conduit or hole ranging from ½″ to 1′ in diameter and with the additional attachment can step up to 1 ¼″, 1 ½″ or even 2″ and above. There are two reasons for this. First of all, in the electrical industry most of your time spent running conduit is with sizes ranging from ½″ to 1″. Second, the max diameter of 1″ will not interfere with the conduit spacing of ¾″ or ½″. This device can be used on multiple sized conduits and condulets without interference or bottoming out.

What is claimed is:

1. An enclosure alignment system for providing adjustable marking of the receiving end of a pipe from its origin, comprising a multi-sized tapered threaded housing by which a laser is attached.

2. An enclosure alignment system in accordance to claim 1 wherein an inner housing is provided by which a laser is attached.

3. An enclosure alignment system in accordance to claim 1 wherein three sets of different sized radial threads are embodied on the exterior.

4. An enclosure alignment system in accordance to claim 1 wherein the central core of the device houses a laser emitting illuminating device.
